(19) United States
(12) Patent Application Publication
(10) Pub. No.: US 2007/0088793 A1
(43) Pub. Date: Apr. 19, 2007

(54) Filter for instant messaging

(76) Inventor: Richard A. Landsman, Los Altos, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/252,664

(22) Filed: Oct. 17, 2005

(51) Int. Cl. G06F 15/16

(52) U.S. Cl. 709/207; 709/224

(57) ABSTRACT

The present invention provides for methods and computer programs for filtering instant messages sent to a recipient. An initial instant message is received from a sender, intended for the recipient. Then, a reply message is sent to the sender requesting that the sender perform a verification process. The method monitors for an incoming response message from the sender, and when the incoming response message is received, the method determines whether the sender properly completed the verification process.

### CROSS-REFERENCE TO RELATED APPLICATIONS

Not applicable.

### BACKGROUND

1. The Field of the Invention

The present invention relates generally to the receipt of instant messages, and more particularly, to methods and computer programs for filtering unsolicited instant messages.

2. The Relevant Technology

The Internet allows a user to send messages in the form of email or instant message to a recipient located virtually anywhere in the world. There are a number of advantages to sending messages via electronic mail (email) rather than through the U.S. Postal Service. Email requires only seconds for the sender's message to be received by a recipient. The receiver can read the sender's message and may respond, save, print, or forward the message. Messages a user receives can be organized into convenient electronic folders and saved for as long as the user wishes without taking up office space. Due to these advantages, email has become many people's principal means of communicating with the world.

In recent years, instant messaging has also grown in popularity because of the instantaneous nature in which it allows users to communicate. Further, instant messaging allows users to engage in a constant exchange of messages much more easily than email. Because of the ease and cost effectiveness of instant messaging, many people are using instant messaging where they would have used the telephone in the past.

Despite the advantages of email and instant messaging, certain drawbacks exist. Most notably, email users often suffer a deluge of unwanted email messages, commonly referred to as “junk mail” or “spam.” The problem of spam is well known and has received considerable attention. Users of e-mail systems are spending an increasing amount of time separating their regular e-mail messages from unwanted e-mail messages. Often, a user's email address receives so much spam email that the only resort is to change email addresses.

More recently, instant messaging users have also been the target of unwanted messages. Messaging spam, commonly referred to as “spim” (IM Spam), is the delivery of unwanted messages where the target is instant messaging services. Many instant messaging systems offer a directory of users, including demographic information such as age and sex. Advertisers gather this information, sign onto the system, and send unsolicited messages to the users.

Unlike email, an instant message user expects almost all of their instant messages to be wanted. When instant messaging is instead used as a spamming means, the desire to use instant messaging can be greatly decreased. In addition, there is no way to filter junk mail sent through instant messaging as can be done in email systems. Furthermore, with security concerns in other instant messaging environments such as chat rooms, the desire to receive messages from only expected and desired users can become increasingly important.

Other distinguishing feathers of instant message increase the need for a functional spim filter. For example, unlike email, instant messages do not include a subject matter line. When a recipient first receives an email message, the recipient typically skims the subject matter information to determine if the entire message should be read, or if the message should be deleted. Conversely, recipients of instant messages must typically read the entire instant message to determine whether the instant message contains wanted or unwanted information. An adequate filtering system for instant messaging will help eliminate the need for users to read through unwanted instant messages.

An attempt to request the advertiser to stop soliciting the user is typically severely hindered since it is common practice for advertisers to either not provide a reply address or to make up a false reply address. Since some instant messaging systems do not require a valid reply address or a valid sender name, most advertisements can be repeatedly sent to thousands of people without giving the recipients a convenient method to request that they be taken off the advertiser's list. Spimmers who do provide valid reply information are often unresponsive to requests to desist. In fact, such a request often merely informs the spimmer that their advertisements have been read, and encourages the sending of more advertisements. Accordingly, thousands of instant messaging users must suffer through a barrage of unwanted instant message advertisements which typically must be read in order to determine that it is an unwanted advertisement. In lieu of a valid reply address, some of these unsolicited commercial messages will provide a non-toll-free number. In order to contact the advertiser, the user must pay for a phone call which may be long distance.

Members of the electronic community have attempted to create numerous roadblocks to stop spamming through both email and instant messaging. These attempts include electronic, legal, and business means. Unfortunately, the junk email and instant messaging communities have generally adapted to and overcome each roadblock.

Because many instant messengers are only willing to accept instant messages from people in their contact lists, savvy advertisers have started generating spim by hacking into users' computers and sending spim to the users' contact lists. Because the message comes from a trusted source, the recipient is subjected to the advertiser's spim, or the recipient unknowingly clicks on a link containing pornography or other unwanted material.

Another common strategy employed by spimmers is to pose as real people in chatrooms and persuade other chatters to invite them to their contact lists. Once a spimmer is included on a contact list, the spimmer can send unlimited spim to the unsuspecting recipient.

Like email spam, instant messaging spam can be a dangerous vehicle that can carry computer viruses that infect the recipient's machine. Spim often entices users into clicking on hyperlinks that provide a doorway for viruses to enter a corporate network.

Because no adequate protection against spim exists, in order to combat spim, many users elect to receive instant messages only from people already on their contact lists (also referred to as “Messenger List”, “Buddy List”, “Allow List”). Consequently, such users frequently block important instant messages from senders who have not yet been added to the users' contact lists. Furthermore, because instant messaging is gaining in popularity, more people will be relying on instant messaging instead of email as their primary means of communication. Therefore, fewer people will be willing to limit their instant messaging conversations to those already on a contact list.

Some instant messaging clients have provided users with the ability to block certain senders from adding the users to their contact lists. By preventing a sender from adding a user to their contact list, the sender is unable to send the user an instant message. To block a sender from adding a user to their contact list, the user is typically notified when any sender adds the user to their contact list. If the sender is a stranger or an unwanted sender, the user is allowed to block the sender from seeing when the user is online. Although this method does have the potential of giving the user control over who can send instant messages, it also possesses various shortcomings. First, it is impossible for a user to know the motive of every person who adds the user to a contact list. Thus, the user may inadvertently block instant messages that would otherwise be accepted. Second, this technique requires the user to take time to determine whether every person who adds the user to a contact list is an accepted sender. This process takes time and merely replaces the annoyance of receiving spim with the annoyance of preventing spim.

### SUMMARY OF THE INVENTION

These and other limitations are overcome by embodiments of the present invention, which relate to systems and methods for filtering unwanted instant messages. Embodiments of the present invention include an instant messaging filter for preventing certain unwanted instant messages from being displayed to a recipient. The instant messaging filter includes a processor for receiving an initial instant message from a sender intended for the recipient. Once the initial instant message is received, the filter sends a reply message to the sender requesting that the sender perform a verification process. The verification process is any process that helps insure that the sender is a human, as opposed to a machine. For example, the verification process may include asking the sender a simple question and requiring the sender to correctly answer the question. Alternatively, the verification process may include displaying a string of machine-unparseable text to the sender, and requiring the sender to correctly enter the text string. Once the sender completes the verification process, the sender sends a response message, containing the response to the verification request.

The filter receives the response message from the sender and determines if the sender has properly completed the verification process. If the sender does complete the verification process, the initial instant message is displayed to the recipient.

After the initial instant message is displayed to the user, the instant messaging filter of the present invention may allow all subsequent instant messages sent from the sender to the recipient to be immediately displayed so that the sender is only required to perform the verification process one time, i.e., after the sending of the initial instant message.

The instant messaging filter may be included in a software package containing the instant messaging client to be loaded on a user's computer, or may be located on a central instant messaging server, so that the instant messaging filtering service may be provided to all instant messaging clients utilizing the central server.

The instant messaging filter of the present invention may include various other feature, including an accept list and a block list. The accept list contains names and/or addresses of trusted instant messaging senders. When an instant message arrives from a sender whose name or address is present on the accept list, the instant message is automatically displayed to the recipient. Conversely, the block list contains names and/or addresses of instant messaging senders that the recipient does not want to receive instant messages from. When an instant message arrives from a sender whose name or address is present on the block list, the instant message is automatically either deleted or placed in a pending folder. The pending folder contains instant messages that were not displayed to the user. The pending folder provides the user with the option of viewing the pending instant messages at a later time, or permanently deleting them.

These and other advantages and features of the present invention will become more fully apparent from the following description and appended claims, or may be learned by the practice of the invention as set forth hereinafter.

### BRIEF DESCRIPTION OF THE DRAWINGS

To further clarify the features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1a illustrates a block diagram of an exemplary network in which an instant messaging system can operate, according to one embodiment of the invention, depicting a spim filter installed on an instant messaging client.

FIG. 1b illustrates a block diagram of another embodiment of a network system in which an instant messaging system can operate, illustrating a spim filter installed on an instant messaging server.

FIG. 2 is an example of machine-unparseable text that may be used as part of a verification process.

FIG. 3 is an exemplary block diagram of a spim filter, in accordance with one embodiment of the present invention.

FIG. 4 is a flow diagram of an exemplary method for filtering instant messages.

FIG. 5 is a more detailed flow diagram of an exemplary method for filtering instant messages.

### DETAILED DESCRIPTION OF EXEMPLARY EMBODIMENTS

The present invention extends to filtering systems for instant messaging systems. The embodiments of the present invention may comprise a special purpose or general-purpose computer including various computer hardware, as discussed in greater detail below.

The present invention provides for methods and systems for reducing or eliminating the number of unwanted instant messages that are delivered to an instant messaging user. As noted above, junk mail that is delivered via instant messaging is commonly referred to as “spim” (IM Spam). The term “spim” will be used herein to refer to any kind of unwanted instant messages, whether transmitted by an individual, company, machine, or any other instant messaging transmitting means. The term “spim” will include commercial and non-commercial instant messages. A spim message may be one that is delivered to a single individual user, or may be a mass message sent to a large number of instant messaging addresses.

Instant messaging differs from standard email in a number of ways. Instant messaging is the act of communicating between two or more people over a network such as the Internet in a near instantaneous manner. Therefore, unlike email, correspondence via instant messaging takes place real-time. The real-time nature of instant messaging further complicates the ability to efficiently and effectively filter out

Furthermore, messages arriving via instant messaging are not typically saved in the same manner as email. While email allows the recipient to store email messages indefinitely in designated folders, instant messages normally arrive and are stored in RAM or some other volatile memory until the user closes the instant messaging client. Because instant messages typically are not saved for long periods of time, it is difficult to monitor a user's past treatment of received instant messages as a means for filtering out spim.

An additional difference between email and instant messaging lies in the scope of recipients a sender can send messages to. Where email allows a user to send an email to virtually any email address in existence, an instant message can only be sent to a user that is currently online. Another limitation shared by many instant messaging clients is that the user initiating an instant message can only send messages to those included in a contact list of some kind. Because of the differences that exist between e-mail and instant messaging, the solutions for minimizing email spam are not generally applicable to instant messaging spim.

To combat unwanted instant messages, the present invention provides instant message filters for deterring spimmers, and for reducing the amount of spim received by users of the present invention. In general, the invention accomplishes this by sending verification messages to unrecognized instant message senders to verify certain information before the original instant message is sent to the user of the present invention. Prior to describing the details of the invention, an exemplary network system will be described in which the present invention can operate.

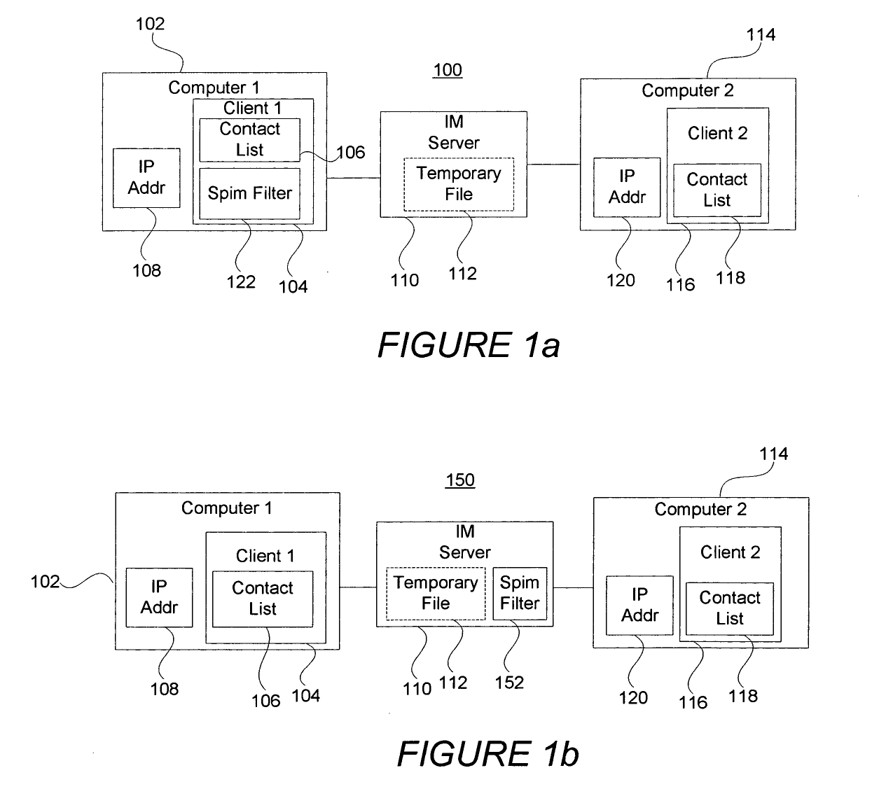

FIG. 1a is a block diagram of a generic instant messaging system 100 in which the present invention can operate. The user of the computer 102 will be referred to herein as either the “recipient” or the “first user.” The recipient or first user may also be referred to herein with reference numeral 102 since that person will be using computer 102. The user of the computer 114 will be referred to as either the “sender” or the “second user.” The sender or second user may also be referred to herein with reference numeral 114 since that person will be using computer 114. Recipient 102 and sender 114 will be used consistently throughout, even though both users are able to send and receive instant messages. Computer 102 includes an instant messaging client software 104 to allow the recipient to send and receive instant messages on computer 102. The client software 104 connects to the instant messaging server 110, which may or may not use a proprietary protocol. The recipient may login to server 110, typically by entering a username and password. Although different instant messaging servers may differ in the information gathered from the clients upon logging in, the server typically collects connection information such as the IP address 108 of the client computer 102, along with the names of those included in a contact list 106.

Server 110 typically creates a temporary file 112 having the connection information and the contacts list. Server 110 then checks to see if any of the users in contact list 106 are currently logged in. If any of the contacts are logged in, server 110 sends a message to client software 104 including necessary connection information of those contacts. Upon receiving this information, client software 104 may notify the recipient of the contacts that are currently online. Server 110 may also send connection information for the user of client software 104 to those same contacts.

Once the recipient 102 is notified of the contacts that are online, the recipient may enter messages into client software 104 and send the messages to a sender who is also logged in. The sender, who has logged in using similar steps as the recipient, receives the message from the recipient via client software 116 in an “instantaneous” manner, i.e., an insignificant delay. The recipient and sender can continue to exchange messages in an instantaneous manner until one of the users logs off. Clients 104 and 116 typically provide a display window to the respective users which includes a scrolling dialog of the conversation, where both user's instant messages appear. The messages exchanged between the first and second clients 104 and 116 may either be transmitted through server 110, or directly between clients 104 and 116, depending on the protocol the instant messaging provider uses.

When a user does log off (e.g., the recipient), client software 104 notifies instant messaging server 110, which terminates the user's session. Server 110 sends messages to the clients of each contact that is currently online to indicate that the recipient is no longer online. Then, server 110 typically deletes temporary file 112.

While the description of FIG. 1a limits the contacts with whom each user may exchange instant messages with to those contacts listed in a contact list, it is possible that an instant messaging system could allow a user to exchange instant messages with other users who are not included in the contact list. For example, an instant messaging client may allow a user to enter contact information for any user, and the server may determine if that user is currently online in a similar manner as was done with the contact list.

Although the description of FIG. 1a describes an exemplary instant messaging system, the exact details of actual instant messaging systems often vary. However, the principles of the present invention may be applied to any instant messaging system now in existence or which may be developed in the future that allows at least two users to exchange messages instantaneously over an electronic medium.

As detailed below, sender 114 may be an unwanted spimmer attempting to send unwanted instant messages to the recipient. The present invention includes a spim filter that may be installed either on computer 102 or on server 110. In the example of FIG. 1a, a spim filter 122 is installed with client software 104 on computer 102. There may be multiple instant messenger users on a network having spim filter 122 installed, but the following description will exemplarily focus only on one such user. When client software 104 receives an initial instant message from client software 116, instead of immediately displaying the received instant message to the recipient, client software 104 sends a reply message back to client software 116. The reply message may be in the form of another instant message, or may be any other message format such as email. The reply message contains a request that the sender of client software 116 complete a verification process that must be completed prior to displaying the initial instant message to the recipient. When the sender 114 completes the verification process, client software 116 sends a response message back to client software 104 of the recipient. The response message may be in the form of another instant message, or may be any other message format such as email. Spim filter 122 again intercepts the response message and determines if the verification process was properly completed. If the verification process was properly completed, the contents of the initial message are displayed to the recipient 102.

The verification process may include any number of verification messages that are designed to be answered by a person, as opposed to a machine. The great majority of spim that is sent is produced by machines, or “bots.” By forcing the sender of the initial instant message to complete the verification process prior to delivering the initial instant message, as disclosed herein, the large majority of spim can be blocked because machine is unable to properly complete the verification process without a great deal of difficulty.

By way of example, one method by which the verification process may be performed is for the reply message to ask the sender to answer one or more predetermined questions. For example, if the recipient would like to block all other users who do not personally know the recipient, the predetermined question may be: “What is the name of the recipient's spouse?” On the other hand, if the recipient would only like to block instant messages sent by a machine, the predetermined question may be:

“What sport is played with a ball and a bat?”

“What does three times three equal?”

“What do leaves grow on?”

“Salsa is a type of (a) spicy food, (b) insect, (c) Latin dance, (d) airplane.
Choose all that apply”

Most humans can easily answer theses questions, but it would be a difficult task to program a computer that could answer them.

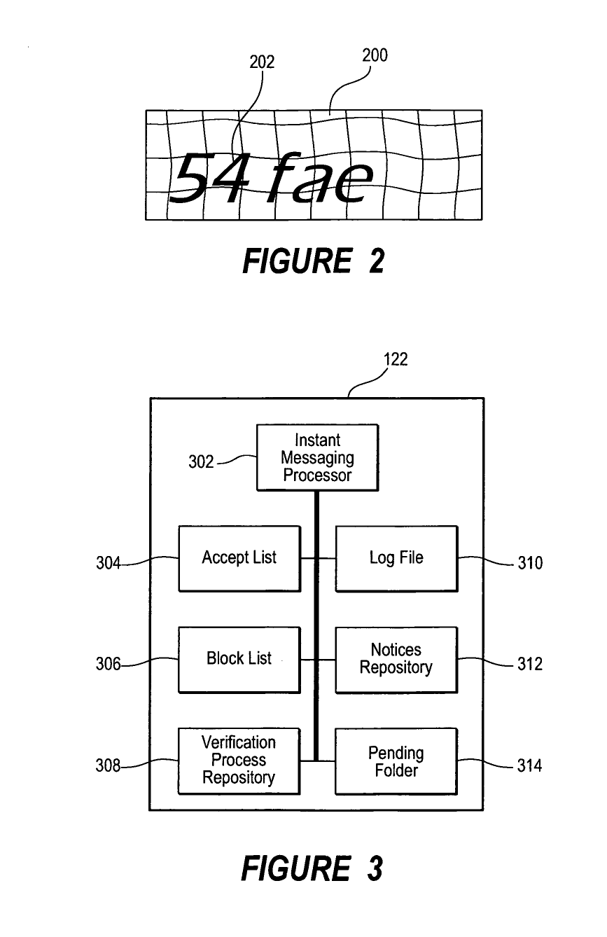

Alternatively, the verification may consist of sending the sender an image containing machine-unparseable text, where the user is required to enter the text contained in the image. FIG. 2 depicts an example of an image 200 containing text 202 that would be difficult for a machine to recognize. However, a person can easily see the text 202 (i.e., “54fae”) and enter it into computer 114 in order to properly complete the verification process.

The above verification processes are merely examples of the verification process that may be used in accordance with the present invention. Many other verification processes may be used in order to provide a deterrent to spimmers. Essentially, any verification process that would be more difficult for a computer to automatically perform than for a human will suffice.

As mentioned above, in one embodiment, the reply message containing the verification request is in the form of an instant message. In this embodiment, the sender receives the reply message just as any other instant message would be received. Therefore, soon after the sender sends the initial instant message to client software 104, spim filter 122 intercepts the message and sends a reply instant message to the sender requesting the sender to complete a verification process.

Client software 116 receives the reply instant message and displays it to the sender as part of the normal instant message scrolling dialog on the instant messaging consol. The sender can read the verification request and promptly complete the verification process. After completing the verification process, the sender sends a response instant message, usually by simply pressing “Enter.” Upon receipt at computer 102, spim filter 122 again intercepts the message from sender 114. Spim filter 122 then checks the response instant message for validity. If the response instant message contains a properly completed verification, then spim filter 122 causes client software 104 to display the contents of the initial instant message to the recipient (i.e., the user of computer 102). This entire process can be completed in a matter of seconds. The following table is a simple example of one embodiment of a verification process. The column on the left describes what type of instant messaging action is taking place. The column on the right describes the text that is either typed or displayed on an instant messaging client console that corresponds to each instant messaging action.

| Instant Messaging Action | Text |
|---|---|
| Initial instant message | John, how are you? |
| sent by sender | |
| Reply message sent to | THIS RECIPIENT REQUIRES YOU TO |
| sender: | ANSWER A SIMPLE QUESTION TO |
| | MAKE SURE YOU ARE NOT A |
| | SPIMMER: What is the name |
| | of John's wife? |
| Response message sent | Susan |
| by sender: | |
| Instant message | John, how are you? |
| displayed to recipient: | |

As illustrated above, after the sender enters “Susan” as his response to the verification request, spim filter 122 verifies that “Susan” is the correct answer, and the context of the initial instant message (i.e., “John, how are you”) appears on the recipient's instant messaging dialog consol. The recipient and sender are then allowed to freely exchange instant messages without the threat of spim.

In an alternative embodiment, illustrated in FIG. 1b, a spim filter 152 is installed on IM server 110, instead of on a client computer. In the embodiment of FIG. 1b, the basic functionality of the spim filter does not change from that of FIG. 1a. However, instead of client software 104 managing the sending of the reply message, receiving of the response message, and determining if the sender has properly completed the verification process, server 110 manages these steps. Therefore, client software 104 does not receive the initial instant message from the sender's client software 116 until the server has ensured that the sender has properly completed the verification process. Once the sender has properly completed the verification process, the contents of the initial instant message are sent to client software 104 and displayed to the recipient.

Installing the spim filter 152 on instant messaging server 110 has the advantage that spim can be filtered for all client computers serviced by instant messaging server 110. On the other hand, installing the spim filter 122 on a client, as shown in FIG. 1a, is beneficial when the instant messaging provider does not have an adequate spim filter installed on instant messaging server 110. In either case, as described above, the instant message filtering technique of the present invention is performed by spim filter 122 or 152, which can be configured as an add-on to existing instant messaging software or can be programmed into instant messaging software.

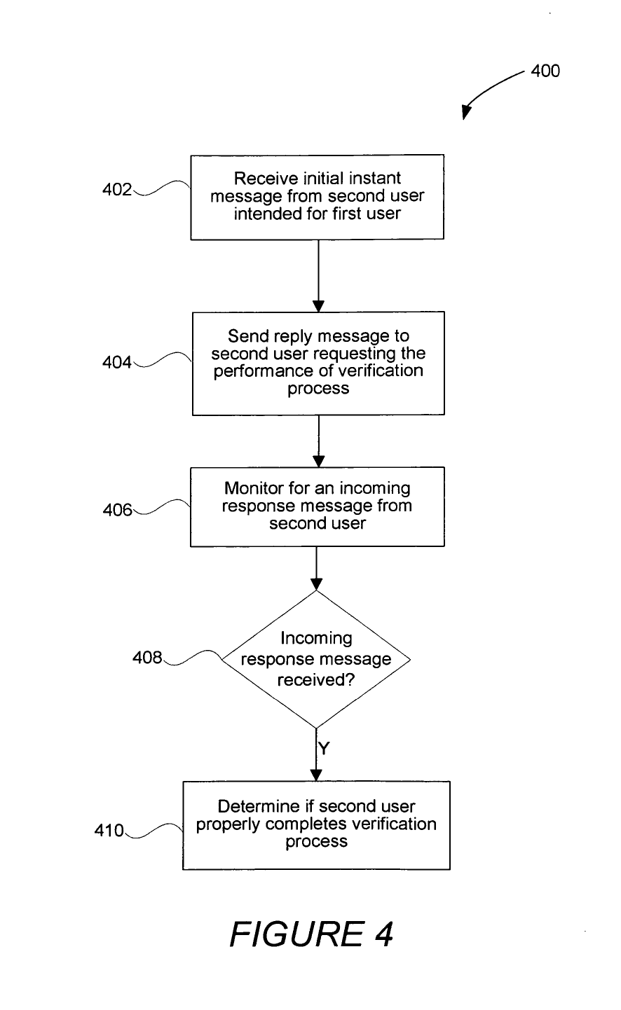

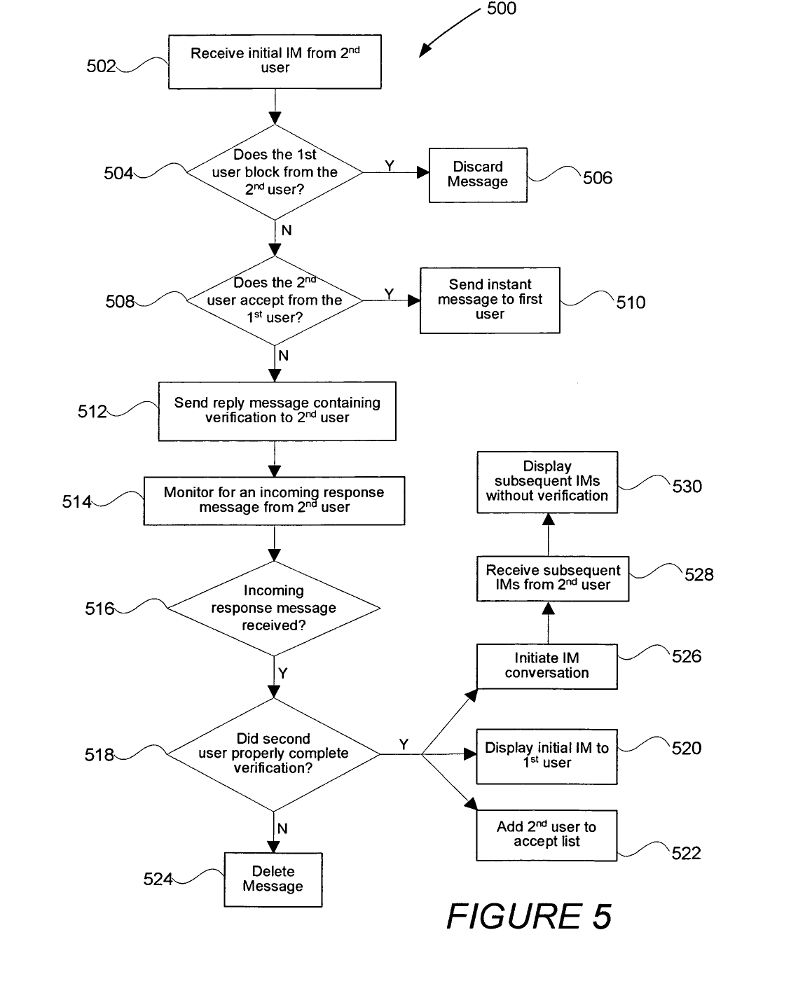

FIG. 3 is a block diagram of modules that may be included in spim filter 122 or 152 to accomplish the features of the present invention. The mail processor 302 is the main transmission and processing component that retrieves and/or accepts incoming instant messages and filters them appropriately. Each incoming instant message is examined and processed by this component according to the flow charts in FIG. 4 or 5. During these steps, mail processor 302 may utilize some or all of the secondary modules of spim filter 122. These modules include an accept list 304, a block list 306, verification process repository 308, log file 310, and notices repository 312.

The accept list 304 and block list 306 may be located either on client software 104, or on instant messaging server 110, depending on which embodiment is being employed. Typically, accept list 304 and block list 306 are located with spim filter 122, as illustrated in FIG. 1a. However, where spim filter 122 is installed on server 110, as illustrated in FIG. 1b, accept list 304 and block list 306 may be permanently installed on client software 104, and uploaded to server 110 each time the recipient logs on. Accept list 304 contains identities of instant messaging users that are permitted to communicate unimpeded with the recipient. Any incoming instant message from a user contained in the accept list will be permitted to reach the recipient without first completing the verification process. Accept list 304 may simply be comprised of the user's contacts list, or a mirror image thereof. Alternatively, accept list 304 may be a separate data module whose contents are mutually exclusive from the user's contact list.

Accept list 304 may contain individual entries, such as John@example.com (an Internet style address), or patterns such as “[all]@example.com. This pattern could indicate that all messages from senders in the “example.com” domain should be accepted and passed onto the recipient unimpeded.

In one embodiment, accept list 304 is automatically created and maintained. For example, when a sender of an initial message properly completes the verification process, the identification of the sender may be automatically added to the accept list 304. In addition, the identities of everyone the recipient has sent instant messages to may be automatically added to the accept list 304, operating on the assumption that the recipient only writes instant messages to individuals from whom the recipient would also accept instant messages from. Alternatively, the user may manually add or delete entries on accept list 304.

Use of an accept list to automatically allow delivery of instant messages for those in the accept list may not always be prudent. As mentioned previously, many spimmers generate spim by hacking into users' computers and sending spim to the hacked users' contact lists. If the identity of the hacked user is also included in the recipient's accept list, the spim will arrive to the recipient without any type of filtering. Therefore, use of an accept list is an optional feature.

Block list 306 contains identities of instant messaging users that are not permitted to communicate with the recipient. This list, just like accept list 304, may contain individual entries, such as “John_Smith@example.com” or patterns such as “[all]@example.com.” Block list 306 is typically manually maintained by the recipient to ensure that a non-spimmer is not inadvertently added to block list 306. If a spimmer correctly completes the verification process and reaches the recipient against the recipient's wishes, the recipient can manually add the spimmer's identity to block list 306. From that point forward, any incoming messages from that sender would be either deleted or placed in a pending folder, as described in further detail below. Like accept list 304, block list 306 is also optional.

Note that block list 306 preferably takes precedence over accept list 304. If a message sender's identity exists on or matches patterns on both the block and accept list 304 and 306, the message is blocked. This is necessary in order to have ultimate blocking control over an unwanted message sender who gains admission to accept list 304 (by properly completing a verification process).

Verification process repository 308 includes, preferably, one or more verification messages and corresponding answers. When composing a verification message, mail processor retrieves contents for the verification message from repository 308. The verification messages (and answers) stored in repository 308 could be included as part of a pre-built, or commercial release of a method and system according to the present invention. For example, where machine-unparseable text is used, as illustrated in FIG. 2, repository 308 could include an image generator creating random strings of text. However, it may not be wise to include a list of questions and answers as part of the pre-built or commercial release of the method and system according to the present invention. This practice would allow a spimmer to procure the fixed list of questions and create an automated program capable of recognizing and answering the limited questions therein. Instead, a feature of the present invention is that each user himself enters verification questions and answers into repository 308. By having each user compose and enter their own verification questions, the possible permutations are limited only by human imagination. In such a case, it would be extremely difficult, if at all possible, to automate the answering of verification processes because the variety of possible verification messages would be too great.

When creating and entering a question, a user should strive to pick a topic and level of difficulty that do not exceed the mental capabilities of those with whom they expect to communicate. Choosing verification messages that few people could answer will have the effect of unintentionally blocking desired communications. (Note—specialized or difficult verification messages could have a beneficial effect. A user could choose questions of a very personal nature so only people very close to him would succeed in being able to correctly answer the question and therefore communicate via instant messaging. This might be a desired approach for wealthy or famous people.)

To enter a verification question, the user specifies, via an interface provided by client software 104 or filter 122, 125, the new question and answer. This question should, in some way, be able to elicit a predictable, printable response from a human. The user may enter multiple correct answers. Any response to the question that matches one of the answers entered is considered a valid and correct response. When matching a response to valid answers, the filter 122 or 152 desirably enables (or the user has the option of enabling) certain features. One of these features is case insensitivity. If enabled, all matches to the answer list are performed without regard to case. A second feature causes whitespace (i.e., spaces, tabs, linefeeds, and the like) to be ignored. If selected, all whitespace characters are removed from the beginning and trailing edges of the responses and all groupings of multiple, adjacent whitespace characters within the verification message are replaced by a single space. This is done before comparisons are made to accept list 304.

Other features are also conceivable. For example, it would be possible for the filter 122 or 152 to understand common misspellings of words and compensate before determining the validity of a response. Many of today's word processors have this ability. For example, if the verification process included the question, “How many wheels on a car?”, the following responses might be considered as correct: “4”, “four”, “for”, and “fore” (“for” and “fore” help accommodate human error). The user could enable the case insensitivity and whitespace ignore options. In this situation, the following responses would be considered valid: “4”, “4”, “FOUR”, “foRe”, and the like.

There is a benefit to having multiple verification messages in repository 308—it becomes possible to rotate or vary the verification message used for each incoming unverified sender. By having multiple verification messages and rotating their use, it becomes difficult for a person or organization to catalog all the verification messages used by a particular person and use this knowledge in an attempt to automate responses to that individual. For example, if a user of this invention always used the question, “What color is an orange?”, a solicitation company could record the answer and automate mailings to that individual by programming software to automatically respond with “orange” to any verification request from that individual. The use of a large verification message repository makes this unlikely.

The reply instant message may merely contain a brief verification process as described above, or may also include a header message containing a notice. The notices that may be included with the reply messages may be stored in a location in memory, called the “notices repository” 312.

When a notice is included, the notice would typically be located in the reply message so that it is the first thing that the sender reads when the reply message is received (with the included verification request). The notice can be anything the user wants. For example, the notice may describe the reason for the reply message and verification process, and a description of the process that the sender must complete in order to reach the recipient. In addition, it might be advisable to include an alternate contact means such as an address or fax number where the recipient can be reached. This would be valuable if the sender, for some reason such as technical difficulties, cultural differences, or language differences, had trouble correctly responding to the verification request. In such a situation, they could use the auxiliary contact means to reach the recipient. The notice may also include a notice that the recipient does not accept unsolicited commercial communications. Displaying the notice may be different depending on the mechanism of sending the reply message. For example, the notice may be in the form of a link if the reply is sent via instant messaging while, in contrast, if the notice is sent via email, the entire notice may be displayed in the email message. Further, the notice function is entirely optional.

Spim messages that are filtered out using the processes described herein are either automatically deleted, or are placed in a pending folder 314. By placing a message in pending folder 314, it is not permanently deleted. Essentially is becomes marked for deletion which may occur at some future event. This temporary holding of discarded instant messages allows the user to correct an accidental discard or recover a wrongly filtered incoming message. In one embodiment, the user is allowed to view instant messages in discarded messages repository 314, and may respond to these messages either by instant message (if the original sender of the deleted message is online), or by email. The permanent deletion of items in repository 314 can be performed by the user manually, or deletion may automatically occur after a predetermined event, such as after a time interval, or after a certain amount of discarded instant messages have been accumulated in the pending folder 314.

Every significant action that the spim filter 122 performs may, at the option of the user, be logged to the system log file 310. Each action would be noted in this log along with specific information to make the entry useful. For example, an incoming instant message from “John Smith” whose address is on block list 306 might cause a log file entry such as:
“BLOCKED: ‘John Smith’ on Sep. 21, 2005 11:42 am. First line of instant message: ‘Let's meet for lunch’”

The recording of this information is valuable, for example, in order to assist the user in determining whether certain instant messages are being blocked or deleted incorrectly.

The present invention may also be described in terms of methods comprising functional steps and/or non-functional acts. The following is a description of steps and/or acts that may be preformed in practicing the present invention. Usually, functional steps describe the invention in terms of results that are accomplished whereas non-functional acts describe more specific actions for achieving a particular result. Although the functional steps and/or non-functional acts may be described or claimed in a particular order, the present invention is not necessarily limited to any particular ordering or combination of steps and/or acts.

FIGS. 4 and 5 illustrate flow diagrams for various exemplary embodiments of the present invention. The following description of FIGS. 4 and 5 may occasionally refer to corresponding elements from FIGS. 1 and 3. Although reference may be made to a specific element from these figures, such elements are used for illustrative purposes only and are not meant to limit or otherwise narrow the scope of the present invention unless explicitly claimed. Note that portions of the description of method 400 of FIG. 4 may apply to method 500 of FIG. 5, and portions of the description of method 500 of FIG. 5 may likewise apply to method 400 of FIG. 4.

FIG. 4 illustrates a flow diagram for a method 400 of filtering instant messages sent to a first user (i.e., a recipient). Method 400 includes, at 402, receiving an initial instant message from a second user intended for the first user. For example, as illustrated in FIGS. 1a and 1b, the initial message from the user of client software 116 is received either by spim filter 122 or 152, computer 102, or instant messaging server 110.

Method 400 also includes, at 404, sending a reply message to the second user requesting that the second user perform a verification process. Similar to the previous step, the reply message can be sent to the second user either by spim filter 122 or 152, client software 104, or instant messaging server 110. The verification process can be any of the verification processes described above, or any other means of verifying that the initial instant message does not originate from a machine, a commercial advertiser, or noncommercial unwanted solicitation.

Further, method 400 includes, at 406, monitoring for an incoming response message from the second user. At 408, method 400 includes a determination of whether the incoming response message is received. Again, the monitoring for the incoming response message and determination of whether the incoming message is received may be performed either by spim filter 122 or 152, client software 104, or instant messaging server 110. If the incoming response message has been received, method 400 further includes, at 410, determining if the second user properly completes the verification process. As detailed above, the verification process is typically properly completed by submitting a correct answer to a verification message or question contained in the verification request.

Method 400 may include various other features that are not diagrammed in FIG. 4. For example, in the event that the incoming response message is received from the second user at 408, and if the second user properly completed the verification process as determined at 410, method 400 may further include displaying an instant message containing content of the initial instant message to the first user. For example, the content of the initial instant message may be displayed on the computer screen of the user, using a user interface supplied by an instant messaging client. This step may be performed by sending the actual initial instant message to the first user, or by sending a distinct instant message containing a copy of the contents of the initial instant message along with an optional notification to the first user that the second user has properly completed the verification process.

FIG. 5 illustrates a more detailed flow diagram for a method 500 of filtering instant messages sent to a first user. Method 500 includes, at 502, receiving an initial instant message from a second user intended for the first user. At 504, method 500 includes determining whether the first user blocks messages from the second user. This may be performed by determining if information identifying the second user is included on the first user's instant messaging block list 306 of FIG. 3.

If the first user does block messages from the second user, the initial instant message is discarded at 506. In this case, the initial instant message may be either permanently deleted or stored in pending folder 314 of FIG. 3. In the event that the first user does not block instant messages from the second user, method 500 may include, at 508, determining if the first user routinely accepts messages from the second user. This step may be performed by comparing the identity of the second user to the contents of the first user's accept list 304 of FIG. 3. In the event that the first user does accept messages from the second user, method 500 includes, at 510, sending an instant message containing content of the initial instant message to the first user.

In the event that the first user does not routinely accept messages from the second user, method 500 includes, at 512, sending a reply message to the second user requesting that the second user perform a verification process. The content of the verification request is described above. At 514, method 500 monitors for an incoming response message from the second user, and if the incoming message is received at 516, method 500 includes receiving the incoming response message from the second user, and at 518, determining if the second user properly completed the verification process.

In the event that the second user properly completes the verification process, method 500 includes, at 520, displaying an instant message containing content of the initial instant message to the first user. Further, method 500 may include, at 522, updating accept list 304 of FIG. 3 to include the identity of the second user. Once the identity of the second user is included in accept list 304, future instant messages from the second user to the first user will be automatically sent to the first user without requiring the second user to complete a verification process.

Once the second user has property completed the verification process, method 500 includes, at 526, initiating an instant messaging conversation between the first and second users. An instant messaging conversation is defined herein as the series of instant messages that are exchanged between two users. An instant messaging conversation is limited in duration, and lasts until either the first or the second user terminates the conversation. One way in which an instant messaging conversation may be terminated is by one of the users logging off of the instant messaging client software.

During the instant messaging conversation, method 500 includes, at 528, receiving at least one subsequent instant message from the second user. At 530, these subsequent instant messages are displayed to the first user without requiring the second user to perform the verification process again. In other words, after the second user has successfully completed the verification process, the second user is free to send multiple messages during the same instant messaging conversation without being inhibited by spim filter 122. This is true even if method 500 does not include the optional step 522 of adding the identity of the second user to the accept list. Because an instant messaging conversation usually consists of multiple instant messages being exchanged within a short time period, step 530 is beneficial because requiring the second user to complete a verification process for every instant message would be overly burdensome, and because the risk of the second user being “hijacked” by a spimmer during an instant messaging conversation is minimal.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

The invention further extends to computer systems adapted for use with user interfaces that operate as described herein. Those skilled in the art will understand that the invention may be practiced in computing environments with many types of computer system configurations, including personal computers, multi-processor systems, network PCs, minicomputers, mainframe computers, and the like. The invention will be described herein in reference to a distributed computing environment, such as the Internet, where tasks are performed by remote processing devices that are linked through a communications network. In the distributed computing environment, computer-executable instructions and program modules for performing the features of the invention may be located in both local and remote memory storage devices.

The present invention may be embodied in other specific forms without departing from its spirit or essential characteristics. The described embodiments are to be considered in all respects only as illustrative and not restrictive. The following exemplary claim is presented to illustrate various novel features of the present invention. The claim is not exhaustive of the embodiments of the invention, nor is it to be construed as limiting the scope of the invention. Moreover, the invention disclosed in detail herein can be defined with other claims, including those that will be included in any related non-provisional applications that will be filed during the pendency of this provisional application.

What is claimed is:

1. A method for filtering instant messages sent to a first user, the method comprising:
receiving an initial instant message from a second user intended for the first user;
sending a reply message to the second user requesting that the second user perform a verification process;
monitoring for an incoming response message from the second user; and
in the event that the incoming response message is received:
determining if the second user properly completes the verification process.

2. The method as recited in claim 1, wherein the reply message appears to the second user in the form of an instant message reply.

3. The method as recited in claim 1, wherein the incoming response message is an instant message response from the second user.

4. The method as recited in claim 1, further comprising:
receiving the incoming response message from the second user; and
in the event that the second user properly completes the verification process:
displaying the initial instant message to the first user.

5. The method of claim 4, further comprising:
initiating an instant messaging conversation between the first and second users;
receiving at least one subsequent instant message from the second user during the instant messaging conversation; and
displaying the at least one subsequent instant message to the first user without requiring the second user to perform the verification process again while participating in the instant messaging conversation.

6. The method as recited in claim 1, wherein the receiving of the initial instant message and the sending of the reply are performed by an instant messaging filter located at a central server.

7. The method as recited in claim 1, wherein the receiving of the initial instant message and the sending of the reply are performed by an instant messaging filter located on an instant messaging client, wherein the initial instant message is not displayed to the first user until the incoming response message is received and the verification process is complete.

8. The method as recited in claim 1, further comprising:
determining if the first user accepts messages from the second user; and
in the event that the first user accepts messages from the second user:
displaying the instant message to the first user without requiring the second user to completed the verification process.

9. The method as recited in claim 8, wherein determining if the first user accepts messages from the second user comprises determining if information regarding the second user is included on an instant messaging accept list for the first user.

10. The method as recited in claim 9, further comprising:
monitoring identities of users to whom the first user has sent instant messages; and
updating the accept list to include the identities of users to whom the first user has sent instant messages.

11. The method as recited in claim 9, further comprising updating the accept list to include the identity of the second user if the second user properly completes the verification process.

12. The method as recited in claim 1, further comprising:
receiving the incoming response message from the second user; and
in the event that the first user improperly completes the verification process:
sending a reject message to the second user notifying the second user that the verification process was improperly completed.

13. The method of claim 1, further comprising storing the initial message in a storage medium, wherein the initial message is selectively viewable by the first user.

14. A method for filtering instant messages sent to a first user, the method comprising:
receiving an initial instant message from a second user intended for the first user;
sending a reply message to the second user requesting that the second user perform a verification process;
receiving an incoming response message from the second user and determining if the second user properly completes the verification process; and
in the event that the second user properly completes the verification process:
displaying the initial instant message to the first user;
initiating an instant messaging conversation between the first and second users;
receiving at least one subsequent instant message from the second user during the instant messaging conversation; and
displaying the at least one subsequent instant message to the first user without requiring the second user to perform the verification process again while participating in the instant messaging conversation.

15. The method as recited in claim 14, wherein the reply message appears to the second user in the form of an instant message reply.

16. The method as recited in claim 14, wherein the incoming response message is an instant message response from the second user.

17. The method of claim 14, further comprising:
determining if the first user blocks messages from the second user; and
in the event that the first user blocks messages from the second user:
storing the initial instant message in a pending folder.

18. The method as recited in claim 17, more specifically comprising determining if the first user block messages from the second user by determining if information identifying the second user is included on an instant messaging block list for the first user.

19. The method as recited in claim 14, further comprising:
determining if the first user accepts messages from the second user; and
in the event that in the event that the first user accepts messages from the second user:
displaying an instant message containing content of the initial instant message to the first user without requiring the second user to complete the verification process.

20. The method as recited in claim 19, wherein determining if the first user accepts messages from the second user comprises determining if information regarding the second user is included on an instant messaging accept list for the first user.

21. The method as recited in claim 20, further comprising:
monitoring identities of users to whom the first user has sent instant messages; and
updating the accept list to include the identities of users to whom the first user has sent instant messages.

22. The method as recited in claim 20, further comprising updating the accept list to include the identity of the second user if the second user properly completes the verification process.

23. In a computer system that includes an instant messaging client, a computer program product for implementing a method of filtering instant messages sent to a first user, the computer program product comprising one or more computer readable media having stored thereon computer executable instructions that, when executed by a processor, can cause the computer system to perform the following:
receive a initial instant message from a second user intended for the first user;
send a reply message to the second user requesting that the second user perform a verification process;
monitor for an incoming response message from the second user; and
in the event that the incoming response message is received:
determine if the second user properly completes the verification process.

24. An instant messaging filter, comprising:
a processor for causing the filter to perform the following:
receive an initial instant message from a second user intended for a first user;
send a reply message to the second user requesting that the second user perform a verification process;
receive an incoming response message from the second user and determining if the second user properly completes the verification process; and
in the event that the second user properly completes the verification process:
display the initial instant message to the first user;
a pending instant messages folder for storing instant messages that were not displayed by the processor, and for allowing the first user to view and delete the instant messages stored therein.
